(19) United States
(12) Patent Application Publication
(10) Pub. No.: US 2006/0103723 A1
(43) Pub. Date: May 18, 2006

(54) Panoramic stereoscopic video system

(75) Inventor: James J. Scire JR., Vernon, CT (US)

Correspondence Address: IRA S. DORMAN, 330 ROBERTS STREET, SUITE 200, EAST HARTFORD, CT, 06108, US

(73) Assignee: Advanced Fuel Research, Inc.

(21) Appl. No.: 10/992,317

(22) Filed: Nov. 18, 2004

(51) Int. Cl. H04N 7/00

(52) U.S. Cl. 348/36

(57) ABSTRACT

A video system employs three or four panoramic optical devices, fixedly mounted on a stationary support, to provide, without movement, a coherent, visually perceptible stereoscopic image of a common field of view.

### STATEMENT OF GOVERNMENT INTEREST

This invention was made with Government support under contract NNJ04-JC36 awarded by NASA. The Government has certain rights in this invention.

### BACKGROUND OF THE INVENTION

Remote-controlled robots are currently utilized for numerous applications, including outer space operations ranging from the manipulation of satellites in earth orbit to the surveying of distant planets. Such robots serve as valuable tools to both astronauts and also earth-based operators, and will continue to do so as future space missions are conducted.

A primary difficulty in the remote operation of moving equipment is the level of detachment that the operator experiences as he or she views the equipment through video cameras. Ordinary video images do not contain enough depth cues to allow complex operations, such as the mating of parts and spacecraft docking operations, to be accomplished without considerable difficulty, if at all, giving rise not only to the possibility of damage to proximate structures, components and sensor systems, but indeed to mission failures.

Stereoscopic video systems, consisting of two cameras that are displaced to provide disparity between the two images provided, can be utilized to simulate normal human depth perception in the remote environment; such systems must be rotated however in order to follow the movement of a robot being controlled. In addition to other disadvantages, the need to manipulate both the robot and also the cameras in a coordinated fashion burdens and slows the operators, and the cameras require an actuator system to orient them, thereby adding weight, complexity and expense to the system, increasing maintenance and energy requirements, and reducing reliability.

McCall et al. U.S. Pat. No. 6,002,430 describes apparatus for capture of a spherical image by combining two hemispherical images. The patentees disclose enhancements that include using two side-by-side hemispherical lens equipped cameras for stereo-optical viewing.

U.S. Pat. No. 6,141,145, to Nalwa, provides a stereo panoramic viewing system in which a reflective polyhedral element redirects the fields of view of each camera of a plurality of camera sets, to form groups of substantially co-located virtual optical centers at a plurality of locations. Two images may be delivered selectively, preferably one designated left and one designated right, when a user requests an image.

In U.S. Pat. No. 6,392,687 Driscoll, Jr., et al. disclose a stereo vision panoramic camera system comprised of two panoramic camera systems separated by a known distance.

Peleg, et al. U.S. Pat. No. 6,665,003 provides systems for generating left and rights mosaic images for use in facilitating panoramic stereoscopic viewing of a scene. The display system described displays a stereoscopic panoramic image to a viewer by displaying left and right images viewed by a respective one of the viewer's eyes. In U.S. Pat. No. 6,795,109 the same patentees disclose camera arrangements configured to record images in the form of left or right panoramic images of a stereo panoramic pair.

### SUMMARY OF THE INVENTION

Accordingly, it is a broad object of the present invention to provide a video system by which normal human depth perception can be simulated in a remote environment.

It is also an object of the invention to provide such a video system which is highly reliable and relatively light weight, incomplex, and inexpensive, and engenders relatively low energy and maintenance demands.

A more specific object of the invention is to provide a panoramic, semispherical, stereoscopic video system that affords the foregoing features and advantages, and in which the viewing optics are fixedly mounted.

A further specific object of the invention is to provide such a video system wherein the means by which the viewing optics are mounted comprises a stationary head or platform of a remotely controlled robot, and wherein the field of view is dynamically changed, without motion of the head or platform of the robot, in response to movement of a unit operatively attached to an operator, usually his or her head.

It has now been found that certain of the foregoing and related objects of the invention are attained by the provision of a panoramic, semispherical, stereoscopic video system, comprising: support means; camera means, mounted by the support means, for collecting images and converting them to representative electrical signals; a multiplicity of three or four optical devices, fixedly mounted at mutually spaced locations in a multilateral arrangement on the support means, for producing a corresponding multiplicity of panoramic, semispherical images of a common field of view, each of the optical devices being optically connected to the camera means for delivering thereto the image viewed by each optical device; and electronic data processing means operatively connected to the camera means for receiving the representative electrical signals therefrom. The data processing means includes programming means for converting the received electrical signals so as to produce at least one coherent, visually perceptible, stereoscopic image of the common field of view, and in preferred embodiments the programming means will function to select dynamically, from among the signals received from the camera means, signals that represent images (or portions thereof) produced, at any given time, by only two of the optical devices.

The visual scope of the field-of-view image will normally be controlled by an operator, such as through movement communicated to the electronic data processing means of the system from an operatively connected unit containing a visual monitor, so as to create a coherent stereoscopic image of the field to which the operator's gaze is directed (usually by head movement). As used herein, references to a “coherent, visually perceptible, stereoscopic image” comprehends any unified image, in color or black-and-white, that affords depth perception and that can be created, with or without electronic, optical or mechanical aids (e.g., colored or polarizing lenses or filters, alternating-eye shutters, etc.) from separate images obtained from two spatially displaced optics or optical devices.

The camera means employed will usually comprise an array of CCD (charge coupled device) image sensors, and may take the form of either a single camera or a plurality of dedicated CCD cameras corresponding in number to the number of optical devices employed, each camera being operatively connected to the electronic data processing means and being optically connected to one or more of the optical devices. The camera means may be mounted in a fixed position, or the one or more cameras employed may be mounted for movement relative to the optical devices so as to thereby afford, for example, improved resolution.

Preferably, the system will comprise optical devices that have mutually parallel panoramic axes and that are disposed to lie substantially on a common plane (to which the axes are normal) and in a substantially equilateral multilateral relationship (i.e., arranged as a triangle or square). In certain embodiments the semispherical field-of-view image produced by each of the optical devices will be a 360° panorama and/or will encompass at least about a 90° view, taken with reference to the panoramic axis, thereby enabling the field-of-view image produced by each of the optical devices to encompass at least about a full hemisphere. It will be appreciated however that optical devices that are constructed or adapted for viewing substantially less than a full circular panorama (e.g., 90° to 180°) and/or substantially less than a 90° arc, taken with reference to the panoramic axis (e.g., only a 30° to 60° arc), also provide a “semi-spherical” view within the contemplation of the present invention.

Each of the optical devices employed in the system will preferably comprise a structure that includes a section of generally conic form and that provides an image-transmitting outer surface portion, which outer surface portion will desirably be arcuately concave in planes parallel to an axis (i.e., the panoramic axis) about which the section extends. Although, as noted above, the conic-form section may afford only a relatively narrow view, it may also advantageously extend about the entire periphery (circumference) of the optic, depending upon the particular application for which the system is intended. Similarly, while the conic-form section may constitute only a band, or generally frustoconical portion, of the optic, for certain applications it will most desirably terminate in a vertex at one end of the structure (on the panoramic axis) and comprise an image-transmitting optical aperture thereat, enabling the production of at least a substantially full hemispheric field-of-view image.

### BRIEF DESCRIPTION OF THE DRAWINGS

FIG. 1 is a perspective view of a panoramic stereoscopic video system embodying the present invention;

FIG. 2 is a schematic plan view depicting the triangular arrangement of cameras and optic structures employed in the system of FIG. 1.

FIG. 3 is a schematic sectional view depicting one of the camera/optic assemblies utilized in the system;

FIG. 4 is a schematic elevational view depicting a panaromic refracting optic (PRO) utilized in the system and showing the paths of rays that enter it from various angles;

FIGS. 5a, 5b and 5c are perspective, elevational and top plan views, respectively, of a PRO suitable for use in the system of the invention; and

FIG. 6 is a schematic representation of a video system embodying the present invention, utilized as a remotely controlled robotic system.

### DETAILED DESCRIPTION OF THE ILLUSTRATED EMBODIMENTS

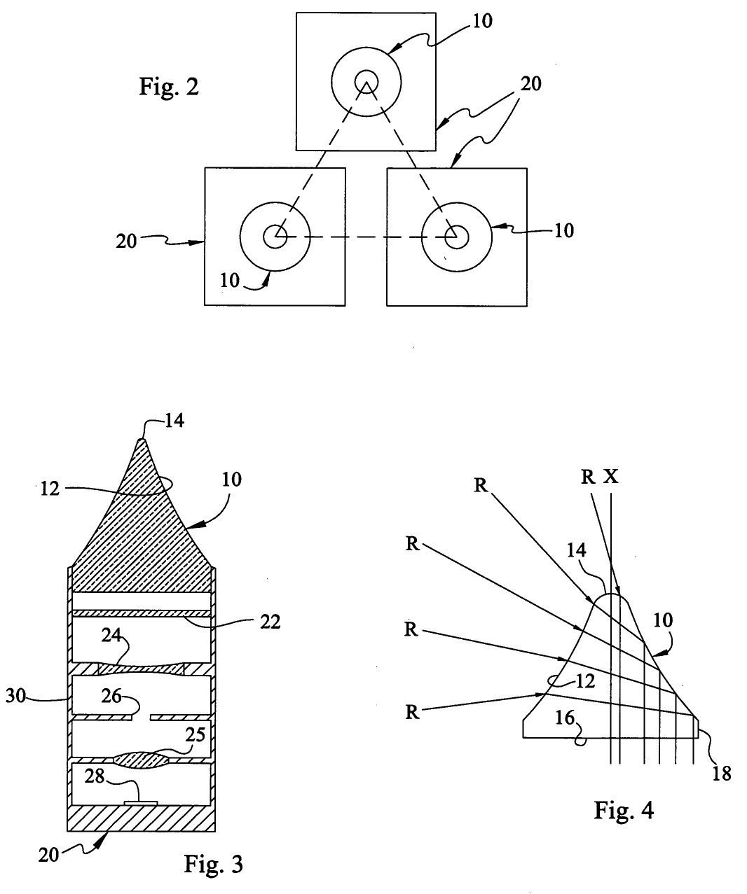

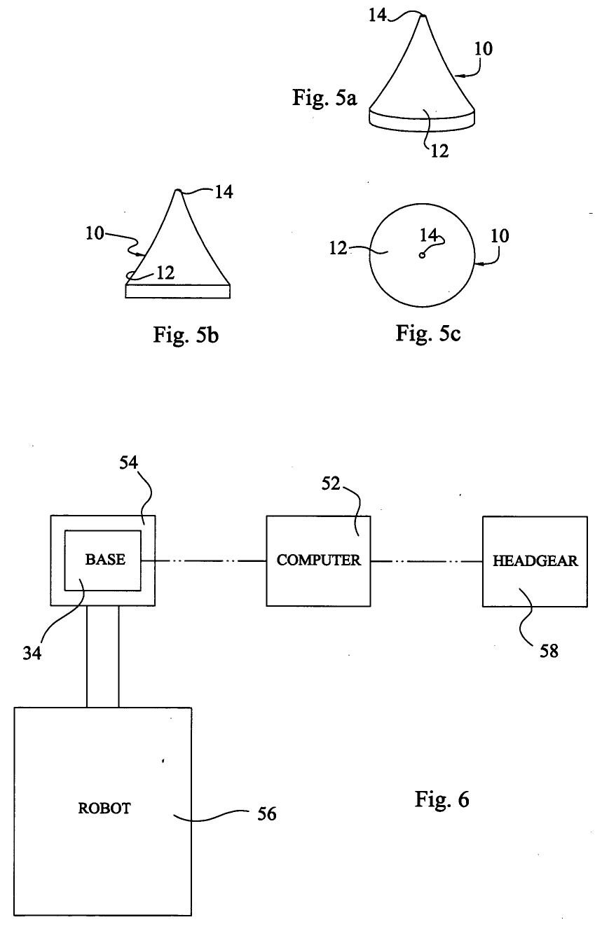

In the best mode presently contemplated for carrying out the invention, a three-camera video system provides stereoscopic images over a hemispherical field of view. Each camera simultaneously collects a full hemispherical field of view using a panoramic refracting optic (PRO) of the character described in Lindner (NASA) U.S. Pat. No. 6,424,470 (the disclosure of which is incorporated hereinto by reference thereto), which is a solid of revolution of the schematics shown in FIGS. 2-9 thereof and depicted in Figures 5a, 5b and 5c of the instant specification, and generally designated by the numeral 10.

As can be seen in FIG. 4 hereof, rays “R” originating from throughout the extended hemispherical field of view (i.e., including a region lying about 10° below the horizon) are transmitted through the concave conic surface 12 and/or the top “cap lens” surface 14 of the optical device, and are refracted as they enter. The rays entering through the lateral surface portion 12 experience total internal reflections from the opposite side of the optic, and are directed outwardly through the bottom surface 16; the rays entering through the cap lens surface portion 14 pass directly through the device, to also exit through bottom surface 16. The radial positions of the rays leaving the bottom of the structure correspond to the angles made by the impinging rays R with the panoramic axis X (i.e., the longitudinal, central axis of the conical structure, or the vertical axis of rotation of the Figure), with the rays coming from near the axis of the optic leaving near the same axis and with rays coming from near horizontal leaving near the circumferential edge 18; the concave side surface 12 enables rays from throughout the hemisphere to exit in nearly parallel alignment.

By way of specific example, a suitable PRO optic structure of the form depicted in the several Figures has a diameter of about 2 inches, with a conical top section that is about 1.8 inches high and a cylindrical bottom section that is about 0.25 inch high. The lateral surface of the top section lies on a circular arc having a radius of about 6.1 inches, taken from points lying about 5.9 inches from the central axis X of the structure and about 3.7 inches above the plane of intersection of the top and bottom sections, and the cap lens surface lies on an arc having a radius of about 0.087 inch. Many structural variations are of course possible in such an optic; for example, the lateral transmitting surface may be generated to lie on a parabolic or elliptical arc or to have other geometric contours.

Optics and viewing devices of the kind described can be fabricated by any appropriate means using any suitable optical material. For example, PROs effective for use herein may be fabricated from acrylic resins by CNC lathe turning or grinding, with appropriate polishing of the ray-transmitting surfaces; crown glass, quartz glass, flint glass, boron glass, diamond, and other optical materials suitable for manufacturing lenses can also be employed as, or in the fabrication of, optics effective for use in the practice of the invention, all as will be evident to those skilled in the art.

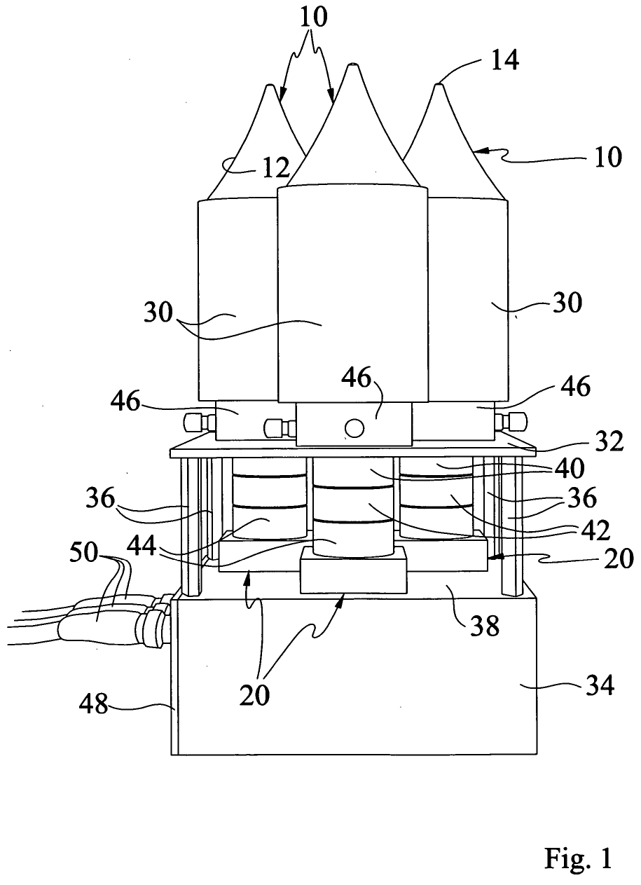

As seen in FIGS. 1 and 2 of the drawings, each of the three cameras, generally designated by the numeral 20, is topped with a PRO device 10 disposed at the vertices of an equilateral triangle. Each optic 10 sees the entire hemisphere above the plane of the cameras 20, as well viewing a region extending about 10° into the hemisphere therebelow, thus enabling stereoscopic views from throughout the full hemisphere (and beyond) to be generated without moving the cameras or the optical devices.

Irrespective of the viewing direction selected, two of the optics 10 will always be non-colinear, and can therefore provide the displacement, or spatial disparity, necessary for three-dimensional viewing image production, provided the devices are selectively accessed (by discriminating among the signals received by the computer from the cameras) so as to provide optimal composites and generally on a dynamic basis to accommodate movement of, or within, the field of view; this is a primary advantage of using multiple (three or four) optical viewing devices. Multi-optic configurations additionally allow the panoramic sections from the different cameras to be used directly in constructing the stereoscopic images, thereby making unnecessary complex transformation processes involving pattern recognition. If the optics 10 are allowed to look past one another in the triangular arrangement described, the minimum interoptic distance for any view is 0.866 times the length of one side of the triangle.

A subsystem comprised of the optic 10, a filter 22, focusing lenses 24 and 25, aperture-defining means 26, and a CCD camera 20 (including a detector array 28), enclosed in a tubular housing 30, is depicted in FIG. 3, and an assembled system embodying the invention is shown in FIG. 1. In one working embodiment, the system has about a five-inch square footprint and stands about ten inches high. It consists of a square aluminum plate 32 supported on a base 34 by posts or spacers 36, with the three CCD board cameras 20 being fastened to a plate 38 comprising the base 34 (within which wiring for the system, not seen, is contained). Commercially available CS-mount video lenses (the exterior structure of which is visible in FIG. 1) are attached directly to the cameras and extend upwardly through the top plate 32, and enable adjustment of focus, zoom, and aperture size.

Three X-Y positioning stages 46 are also mounted to plate 32, just above each lens, and IR-cutoff filters (not seen in this Figure) are mounted therewithin. The mounting tubes 30 (which may comprise threadably interconnected sections to allow variation of the overall lengths of the tubes) are also attached to the positioning stages 46. The PRO device 10 is disposed in the top section of each lens tube 30, and is held in place by nylon-tipped set screws (not seen). A side panel 48 contains BNC jacks for receiving connectors 50 for transmission of the video output signals from the three cameras 20, along with the corresponding power input connectors (not shown). The three video signals are connected to three of the video input channels on an image acquisition board in a desktop computer 52 (shown in FIG. 6).

The software employed to program the electronic data processing means (computer 52) for acquisition and display of the images collected by the described system is developed in LABVIEW graphical application development software, available from National Instruments Corporation, and is organized into four “tabs,” which allow the user to view the component images at different stages in the construction of the 3-D image composites, and to adjust the operating parameters of the program. A “Raw Cameras” tab allows the user to view panoramic images from each of the three cameras; the “One Camera” tab allows the user to closely inspect one of the individual camera images; the “PRO unwrapped” tab displays a portion of one of the raw PRO images electronically manipulated so as to decrease or eliminate distortion and thereby more faithfully simulate what the user, looking in a chosen direction, would see; and a “3-D View” tab displays anaglyph (two-color) 3-D images generated from the extracted views and contains a set of slider controls to allow for rapid adjustment of the selected view. The 3-D images are viewed using colored eyeglasses, with a red left-eye filter and a cyan right-eye filter, to render them coherent. Three ¼-inch-format board-level CCD cameras, having 3.6-mm-by-2.7 mm CCDs with 768 by 494 pixels and equipped with CS mounts which mate with the lenses, are employed in the imaging system. A higher resolution video camera (such as for example the 1600 by 1200 pixel Redlake MEGAPLUS® DT 4000 camera) would however substantially improve resolution and performance, and would therefore be preferable in most instances.

The X-Y positioning stages 46 allow the position of the optics to be adjusted slightly, to better center each above its associated camera. This is done primarily to correct for slight displacements that exist or occur between the center of the lens mount (on the camera) and the center of the optic device CCD, causing the PRO 10 to appear off-center. Preferably, however, the relative positions of the cameras and the lenses will be controlled so that the optic devices can be secured in substantially permanent positions.

As noted above, the side panel 48 on the mounting base 34 contains BNC jacks for the video output signals from the three cameras, along with the corresponding power input connectors; the cameras are powered using individual AC adapters. The three video signal cables are connected to three of the video input channels present on a National Instruments PCI-1409 monochrome image-acquisition board in the desktop computer 52.

The video lens elements 24 and 25, shown in FIG. 3, are a negative top lens element and a positive bottom lens element. The top and bottom lens positions and the aperture openings are each adjustable by use of the adjustment rings 40, 42, 44, respectively (shown in FIG. 1), and scales on each of the rings (not shown) allow the settings to be easily recorded and reproduced.

FIG. 6 illustrates schematically a primary application for the system of the invention, wherein support means, such as the base 34 shown in FIG. 1, is fixedly mounted upon the stationary head member 54 of a robot 56. Video signals from the cameras of the system are received by the electronic data processing means 52, which is programmed to acquire stereoscopic views from the cameras for any given viewing direction. As discussed above, the software “unwraps” the images extracted from the raw PRO signals to provide “non-panoramic” images (i.e., images that better simulate normal human vision) for display on a stereoscopic viewing monitor contained on or within an operator's headgear 58. The software of the computer 52 functions in such manner that the non-panoramic stereoscopic image displayed on the monitor is automatically discriminated from the panoramic field of view, in response to normal movements of the operator's head that would be made to enable him to “see” the desired image as though he were immersed in the environment.

The panoramic stereoscopic video system of the present invention can be utilized for different wavelength bands, provided suitable cameras, focusing optics, and optic device designs are employed. The optical viewing device and the focusing optics must of course be constructed of materials that pass light within a selected operating wavelength band or region, and will normally be designed to minimize imaging aberrations at the effective wavelengths of operation; cameras that respond in the same radiation ranges must of course also be employed.

More particularly, stereoscopic video systems can be developed for various bands in the ultraviolet (wavelengths nominally from 100 nm to 400 nm), the visible (wavelengths nominally from 400 nm to 770 nm), and the infrared (wavelengths nominally from 770 nm to 1 mm), and systems designed to operate in different wavelength regions can effectively be used for providing panoramic stereoscopic imaging in a variety of applications. As will be appreciated, imaging that mimics normal human vision is accomplished with a bandpass covering the visible; imaging of thermal radiation is accomplished with a bandpass in the infrared; and imaging of various forms of luminescence (e.g. chemiluminescence, electroluminescence) maybe accomplished with an appropriate bandpass in the visible or ultraviolet. The system may also be designed with a narrow or a wide bandpass, depending on the application, and it may cover a region that extends, for example, from the ultraviolet to the infrared, with suitable filters being employed, as appropriate, to select a band narrower than the bandpass formed by the other system components.

It will be understood that numerous variations, evident to those skilled in the art, may be made in the system described without departure from the scope of the invention defined. For example, rather than using the PRO device disclosed, and provided suitable matching and optimization measures are taken, the optic may take the form of a fish-eye lens, or a panoramic structure of the kind described in each of U.S. Pat. Nos. 5,473,474, 6,115,193, and 6,175,454, etc.; various arrangements may be employed, where needed, for optical coupling to the associated video camera, and the camera itself may of course be other than the CCD apparatus disclosed.

It will also be appreciated that the system of the invention has many applications in addition to use for outer space operations and robotics. For example, such systems can be utilized for building security surveillance, land mine and bomb disposal, search and rescue operations, police and military scouting missions, crime scene searching, terrain and cavern mapping, advanced surveying, handling of objects in dangerous, inert or vacuum environments, traffic and driver visual aids and, indeed, for entertainment systems, including, for example, children's toys.

Thus it can be seen that the present invention provides a video system by which normal human depth perception can be simulated in a remote environment. The invention provides, more specifically, a panoramic, semispherical, stereoscopic video system in which the viewing optics are fixedly mounted and in which the mounting means may comprise a stationary head or platform of a remote-controlled robot, the field of view being dynamically changed, without motion of the head or platform of the robot, in response to movement of a unit operatively attached to an operator. The video system of the invention is highly reliable, relatively light weight, incomplex, and inexpensive, and it engenders relatively low energy and maintenance demands.

Having thus described the invention, what is claimed is:

1. A panoramic, semispherical, stereoscopic video system, comprising: support means; camera means, mounted by said support means, for collecting images and converting them to representative electrical signals; a multiplicity of three or four optical devices, fixedly mounted at mutually spaced locations in a multilateral arrangement on said support means, for producing a said multiplicity of panoramic, semispherical images of a common field of view, said optical devices having mutually parallel panoramic axes and being optically connected to said camera means for delivering thereto the image viewed by said each optical device; and electronic data processing means operatively connected to said camera means for receiving said representative electrical signals therefrom, and including programming means for converting said received electrical signals for the production of at least one coherent, visually perceptible, stereoscopic image of said common field of view.

2. The system of claim 1 wherein said camera means is also fixedly mounted by said support means.

3. The system of claim 1 wherein said camera means comprises a charge coupled device image sensor.

4. The system of claim 3 wherein said camera means comprises a multiplicity of charge coupled device cameras operatively connected to said electronic data processing means, one of said cameras being optically connected to each of said optical devices.

5. The system of claim 1 comprising three of said optical devices, so mounted in a triangular relationship to one another.

6. The system of claim 5 wherein said optical devices lie substantially on a common plane to which said panoramic axes are normal, and wherein said triangular relationship is substantially equilateral.

7. The system of claim 1 wherein said field-of-view image produced by each of said optical devices is a 360° panorama.

8. The system of claim 1 wherein said field-of-view image produced by each of said optical devices encompasses at least about a 90° view taken with reference to said panoramic axis thereof.

9. The system of claim 1 wherein said field-of-view image produced by each of said optical devices encompasses at least about a full hemisphere.

10. The system of claim 1 wherein each of said optical devices comprises a structure that includes a section of generally conic form and that provides an outer, image-transmitting surface portion.

11. The system of claim 10 wherein said outer surface portion of said each optical device is arcuately concave in planes parallel to said panoramic axis thereof.

12. The system of claim 10 wherein said section of generally conic form extends about the entire periphery of said structure.

13. The system of claim 10 wherein said section of generally conic form terminates in a vertex at one end of said structure and on said panoramic axis thereof.

14. The system of claim 13 wherein said vertex comprises an image-transmitting optical aperture, enabling said each optical device to produce at least a substantially hemispheric field-of-view image.

15. The system of claim 1 wherein each of said optical devices comprises a panoramic refracting optic.

16. The system of claim 1 wherein said programming means functions to select dynamically, from among said signals received from said camera means, signals that represent images produced, at any given time, by only two of said optical devices.

17. A panoramic, semispherical, stereoscopic video system, comprising: support means; camera means, mounted by said support means, for collecting images and converting them to representative electrical signals; a multiplicity of three or four optical devices, fixedly mounted at mutually spaced locations in a multilateral arrangement on said support means, for producing a said corresponding multiplicity of panoramic, semispherical images of a common field of view, each of said optical devices being optically connected to said camera means for delivering thereto the image viewed by said each optical device; and electronic data processing means operatively connected to said camera means for receiving said representative electrical signals therefrom, and including programming means for converting said received electrical signals for the production of at least one coherent, visually perceptible, stereoscopic image of said common field of view, said programming means functioning to select dynamically, from among said signals received from said camera means, signals that represent images produced, at any given time, by only two of said optical devices.

18. The system of claim 17 wherein said camera means comprises a multiplicity of charge coupled device cameras operatively connected to said electronic data processing means, one of said cameras being optically connected to each of said optical devices.

19. The system of claim 17 wherein said optical devices lie substantially on a common plane, and said multilateral relationship is substantially equilateral.

20. The system of claim 17 wherein each of said optical devices comprises a structure that includes a section of generally conic form and that provides an outer, image-transmitting surface portion, and wherein said outer surface portion of said each optical device is arcuately concave in planes parallel to a panoramic axis of said each device about which said section of said structure extends.

21. The system of claim 17 wherein said section of generally conic form extends about the entire periphery of said structure, wherein said section of generally conic form terminates in a vertex at one end of said structure, comprising an image-transmitting optical aperture, and wherein each of said optical devices comprises a panoramic refracting optic.

22. The system of claim 1 additionally including a robot having a fixedly disposed head member on which said support means is also fixedly disposed.

23. The system of claim 22 further including a remote monitor operatively connected to said electronic data processing means for viewing of said stereoscopic image of said common field of view.

24. The system of claim 23 wherein said remote monitor is movable for selectively controlling the visual scope of said common field of view without movement of said head member of said robot or said support means.

25. The system of claim 23 wherein said remote monitor is constructed to be worn on the head of a human operator.

26. The system of claim 17 additionally including a robot having a fixedly disposed head member on which said support means is also fixedly disposed.

27. The system of claim 26 further including a remote monitor operatively connected to said electronic data processing means for viewing of said stereoscopic image of said common field of view.

28. The system of claim 27 wherein said remote monitor is movable for selectively controlling the visual scope of said common field of view without movement of said head member of said robot or said support means.

29. The system of claim 27 wherein said remote monitor is constructed to be worn on the head of a human operator.
